(19) United States
(12) Patent Application Publication
(10) Pub. No.: US 2015/0103465 A1
(43) Pub. Date: Apr. 16, 2015

(54) ULTRA THIN FILM CAPACITOR AND MANUFACTURING METHOD THEREOF

(71) Applicant: Samsung Electro-Mechanics Co., Ltd., Suwon (KR)

(72) Inventors: Young Sik Kang, Daejeon (KR); Sung Min Cho, Suwon (KR)

(73) Assignee: Samsung Electro-Mechanics Co., Ltd., Suwon (KR)

(21) Appl. No.: 14/051,845

(22) Filed: Oct. 11, 2013

(51) Int. Cl. H01G 4/33; H01G 4/10; H01G 4/008; H01G 4/30

(52) U.S. Cl. CPC H01G 4/33; H01G 4/30; H01G 4/10; H01G 4/008
USPC 361/301.4; 29/25.42

(57) ABSTRACT

Disclosed herein are an ultra thin film capacitor and a manufacturing method thereof. According to an exemplary embodiment of the present invention, there is provided an ultra thin film capacitor including: a substrate; a dielectric unit formed of thin film dielectric layers alternately stacked with a plurality of internal electrode layers on the substrate; an internal electrode unit formed of the plurality of internal electrode layers alternately stacked with the thin film dielectric layers in the dielectric unit on the substrate, the internal electrode layer including first electrode layers and a second electrode layer made of material having a specific resistance lower than that of the first electrode layer; and via electrodes formed at both sides of the internal electrode unit on the substrate and each being electrically connected alternately with the stacked internal electrode layers. Further, the manufacturing method thereof is proposed.

### BACKGROUND OF THE INVENTION

1. Technical Field

The present invention relates to an ultra thin film capacitor and a manufacturing method thereof. More particularly, the present invention relates to an ultra thin film capacitor capable of implementing a low ESR and a low ESL and a manufacturing method thereof.

2. Description of the Related Art

Recently, as a market of mobile communication devices and portable electronic devices is expanded, a demand for a subminiature capacitor having a high capacitance value has increased. Therefore, a research for a thin film type multi-layered ceramic capacitor (MLCC) capable of obtaining a high capacitance value while being miniaturized has been conducted actively. However, since the thin film type multi-layered ceramic capacitor consists of a multi-layered structure with tens of layers, the thin film type multi-layered capacitor has a high capacitance value but a limitation in reducing a thickness.

Recently, in order to solve the above problems, a development of a thin film type capacitor using a thin film electrode and a dielectric on a silicon substrate has been conducted actively.

However, the thin film type capacitor has a high capacitance but has a limitation of an available electrode meeting characteristics of a dielectric, such that an internal equivalent series resistance (ESR) value parasitic on the capacitor may be high. The smaller the ESR, the better the performance of the capacitor becomes. However, due to the parasitic resistance, an error occurs and a leakage current is generated during the charging and discharging time, which leads to degrade the system performance. Therefore, since the high internal ESR does not meet recent requirements of product performances, such as fast execution speed, low energy consumption, and the like, which are required for a microprocessor unit (MPU), and the like, the high internal ESR cannot but be restrictively used actually.

### RELATED ART DOCUMENT

### Patent Document

(Patent Document 1) U.S. Pat. No. 7,349,195 B2 (Published on Mar. 25, 2008)

### SUMMARY OF THE INVENTION

An object of the present invention is to provide an ultra thin film capacitor capable of reducing an internal ESR and an internal ESL by adding an electrode layer having a low specific resistance to an internal electrode layer alternately stacked with a thin film dielectric layer, and a manufacturing method thereof.

According to an exemplary embodiment of the present invention, there is provided an ultra thin film capacitor, including: a substrate; a dielectric unit formed of thin film dielectric layers alternately stacked with a plurality of internal electrode layers on the substrate; an internal electrode unit formed of the plurality of internal electrode layers alternately stacked with the thin film dielectric layers in the dielectric unit on the substrate, each internal electrode layer including first electrode layers having stacked surfaces contacting the thin film dielectric layers and a second electrode layer formed between the first electrode layers and made of material having a specific resistance lower than that of the first electrode layer; and via electrodes formed at both sides of the internal electrode unit on the substrate and each being electrically connected alternately with the stacked internal electrode layers.

The ultra thin film capacitor may further include: an internal passivation layer formed on the substrate and beneath a coupling structure of the dielectric unit and the internal electrode unit; and an external passivation layer enclosing an outside of the dielectric unit on the substrate.

The internal electrode unit may further include a base electrode layer formed on a bottom portion thereof and a plurality of internal electrode layers may be alternately stacked with the thin film dielectric layers over the base electrode layer.

The thin film dielectric layer may be made of BaSrTiO₃ (BST), SrTiO₃, and BaTiO₃, Pb(Zr, Ti) O₃, or bismuth layered compounds, such as SrBi₄Ti₄O₁₅.

The first electrode layer may be made of Pt. The second electrode layer may be made of one metal material of Cu, Ag, Au, Al, Ru, Ir, Ni, Co, Mo, and W.

According to another exemplary embodiment of the present invention, there is provided an ultra thin film capacitor, including: a substrate; a dielectric unit formed of thin film dielectric layers alternately stacked with a plurality of internal electrode layers on the substrate; an internal electrode unit formed of a plurality of internal electrode layers alternately stacked with the thin film dielectric layers in the dielectric unit on the substrate, each internal electrode layer being formed by stacking the a first electrode layer and a second electrode layer made of material having a specific resistance lower than that of the first electrode layer; and via electrodes formed at both sides of the internal electrode unit on the substrate and each being electrically connected alternately with the stacked internal electrode layers.

The ultra thin film capacitor may further include: an internal passivation layer formed on the substrate and beneath a coupling structure of the dielectric unit and the internal electrode unit; and an external passivation layer enclosing an outside of the dielectric unit on the substrate.

The thin film dielectric layer may be made of BaSrTiO₃ (BST), SrTiO₃, and BaTiO₃, Pb(Zr, Ti)O₃, or bismuth layered compounds, such as SrBi₄Ti₄O₁₅.

The first electrode layer may be made of Pt. The second electrode layer may be made of one metal material of Cu, Ag, Au, Al, Ru, Ir, Ni, Co, Mo, and W.

According to a still exemplary embodiment of the present invention, there is provided a manufacturing method of an ultra thin film capacitor, including: preparing a substrate; forming an internal electrode laminate by alternately stacking a plurality of thin film dielectric layers and a plurality of internal electrode layers on the substrate, each internal electrode layer including first electrode layers having stacked surfaces contacting the thin film dielectric layers and a second electrode layer formed between the first electrode layers and made of material having a specific resistance lower than that of the first electrode layer; and forming via electrodes by forming via holes at both sides of the internal electrode laminate formed on the substrate and electrically and alternately connecting conductive substances filled in the via holes to the stacked internal electrode layers.

The preparing of the substrate may include forming an internal passivation layer on the substrate; in the forming of the internal electrode laminate, the internal electrode laminate is formed on the internal passivation layer and an external passivation layer enclosing an outside of the internal electrode laminate is formed; and in the forming of the via electrodes, the via electrodes are formed by forming the via holes penetrating through the external passivation layer and the internal electrode laminate.

The thin film dielectric layer may be formed by any one of ALD, PEALD, CVD, MOCVD, PECVD, and PVD processes.

The thin film dielectric layer may be made of BaSrTiO₃ (BST), SrTiO₃, and BaTiO₃, Pb(Zr, Ti)O₃, or bismuth layered compounds, such as SrBi₄Ti₄O₁₅.

The first electrode layer may be formed by any one of the ALD, PEALD, CVD, MOCVD, PECVD, and PVD processes and the second electrode layer may be formed by any one of the ALD, PEALD, CVD, MOCVD, PECVD and PVD processes, or a plating process.

The first electrode layer may be made of Pt. The second electrode layer may be made of one metal material of Cu, Ag, Au, Al, Ru, Ir, Ni, Co, Mo, and W.

According to still yet another exemplary embodiment of the present invention, there is provided a manufacturing method of an ultra thin film capacitor, including: preparing a substrate; forming an internal electrode laminate by alternately stacking a plurality of internal electrode layers and a plurality of thin film dielectric layers on the substrate, each internal electrode layer being formed by stacking a first electrode layer and a second electrode layer made of material having a specific resistance lower than that of the first electrode layer; and forming via electrodes by forming via holes at both sides of the internal electrode laminate formed on the substrate and electrically and alternately connecting conductive substances filled in the via holes to the stacked internal electrode layers.

The preparing of the substrate may include forming an internal passivation layer on the substrate; in the forming of the internal electrode laminate, the internal electrode laminate is formed on the internal passivation layer and an external passivation layer enclosing an outside of the internal electrode laminate is formed; and in the forming of the via electrodes, the via electrodes are formed by forming the via holes penetrating through the external passivation layer and the internal electrode laminate.

The thin film dielectric layer may be formed by any one of the ALD, PEALD, CVD, MOCVD, PECVD, and PVD processes using BaSrTiO₃ (BST).

The first electrode layer may be formed by any one of the ALD, PEALD, CVD, MOCVD, PECVD, and PVD processes and the second electrode layer may be formed by any one of the ALD, PEALD, CVD, MOCVD, PECVD and PVD processes, or a plating process.

The first electrode layer may be made of a Pt material and the second electrode layer may be made of one metal material of Cu, Ag, Au, Al, Ru, Ir, Ni, Co, Mo, and W.

### BRIEF DESCRIPTION OF THE DRAWINGS

FIG. 1A is a cross-sectional view schematically illustrating an ultra thin film capacitor according to an exemplary embodiment of the present invention.

FIG. 1B is a cross-sectional view schematically illustrating an ultra thin film capacitor according to another exemplary embodiment of the present invention.

FIG. 2A is a diagram schematically illustrating a stacked structure of a thin film dielectric layer and an internal electrode layer in the ultra thin film capacitor illustrated in FIG. 1A.

FIG. 2B is a diagram schematically illustrating a stacked structure of a thin film dielectric layer and an internal electrode layer in the ultra thin film capacitor illustrated in FIG. 1B.

FIG. 3 is a cross-sectional view schematically illustrating an ultra thin film capacitor according to another exemplary embodiment of the present invention.

FIG. 4A is a cross-sectional view schematically illustrating an ultra thin film capacitor according to an exemplary embodiment of the present invention.

FIG. 4B is a cross-sectional view schematically illustrating an ultra thin film capacitor according to another exemplary embodiment of the present invention.

FIGS. 5A to 5C are diagrams schematically illustrating a manufacturing method of the ultra thin film capacitor illustrated in FIG. 4A.

### DESCRIPTION OF THE PREFERRED EMBODIMENTS

Exemplary embodiments of the present invention for accomplishing the above-mentioned objects will be described with reference to the accompanying drawings. In the description, the same reference numerals will be used to describe the same components of which a detailed description may be omitted in order to allow those skilled in the art to understand the present invention.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

Although a singular form is used in the present description, it may include a plural form as long as it is opposite to the concept of the present invention and is not contradictory in view of interpretation or is used as a clearly different meaning. It should be understood that “include”, “have”, “comprise”, “be configured to include”, and the like, used in the present description do not exclude presence or addition of one or more other characteristic, component, or a combination thereof.

The accompanying drawings referred in the present description may be examples for describing exemplary embodiments of the present invention. In the accompanying drawings, a shape, a size, a thickness, and the like, may be exaggerated in order to effectively describe technical characteristics.

First, an ultra thin film capacitor according to a first exemplary embodiment of the present invention will be described in detail with reference to the accompanying drawings. In the specification, the same reference numerals will be used in order to describe the same components throughout the accompanying drawings.

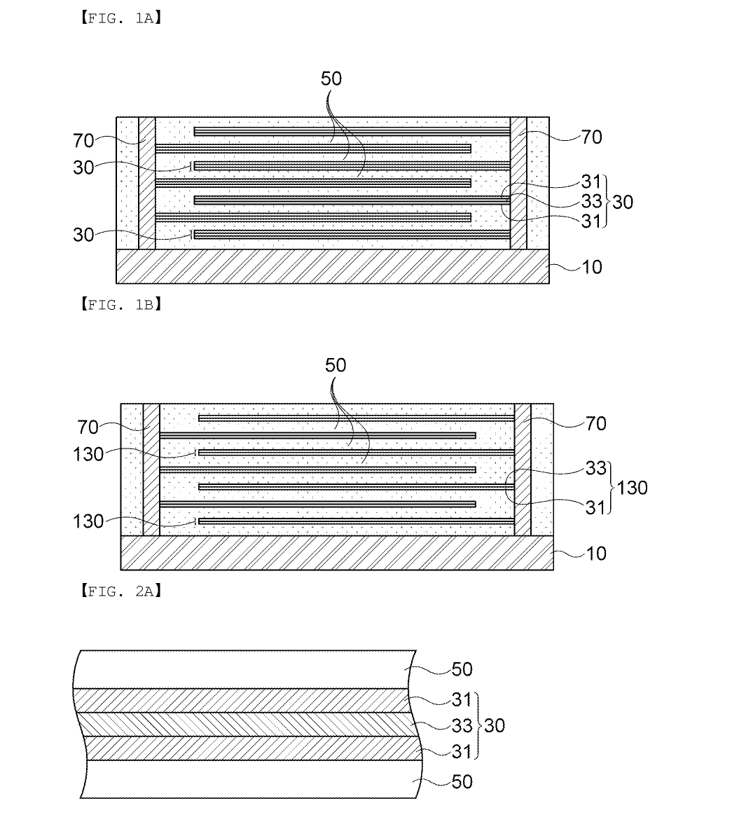

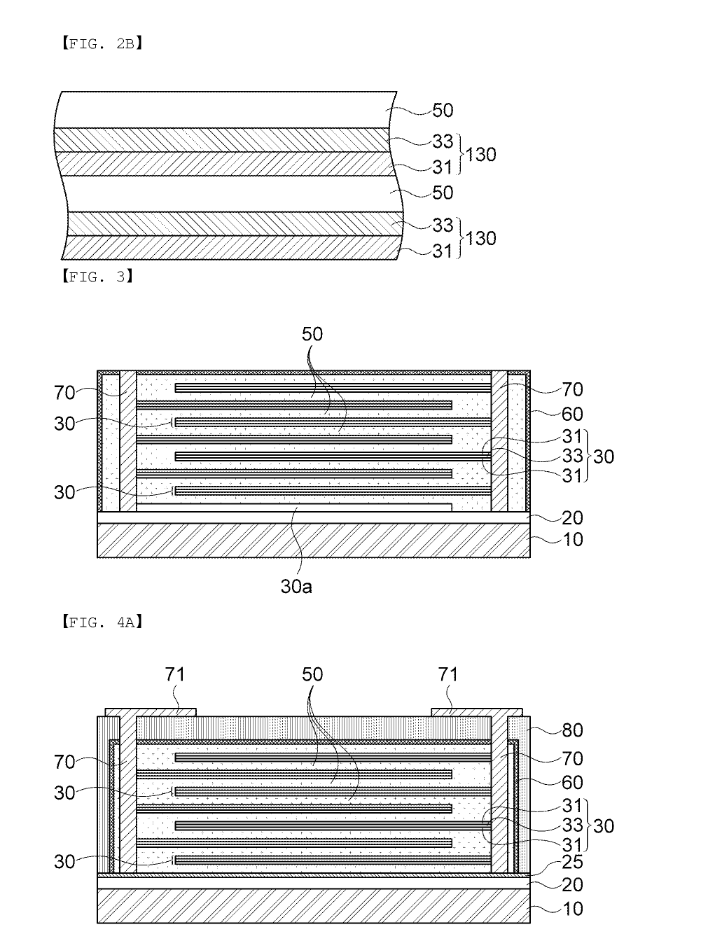

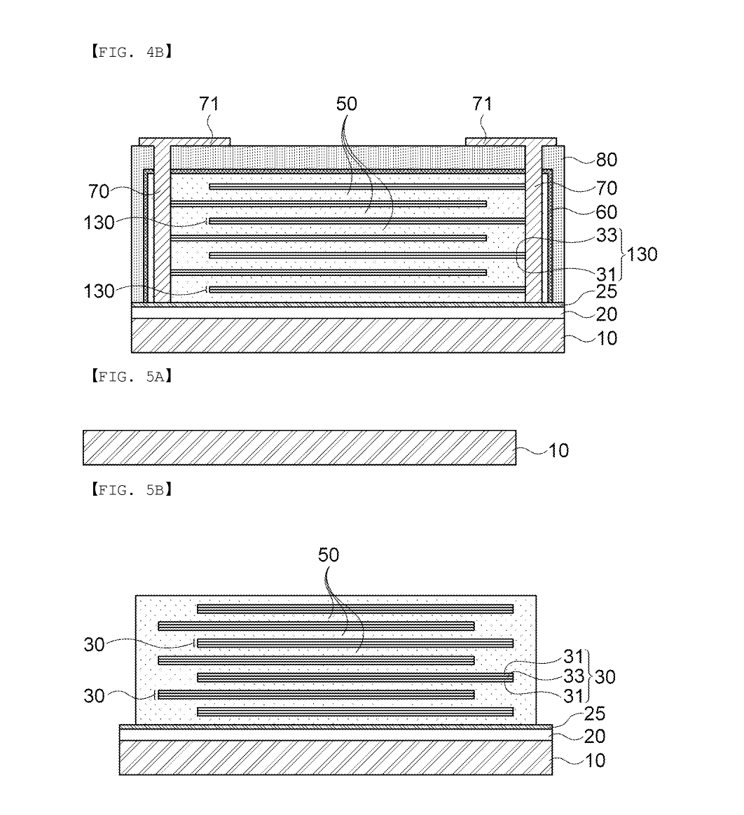

FIG. 1A is a cross-sectional view schematically illustrating an ultra thin film capacitor according to an exemplary embodiment of the present invention, FIG. 2A is a diagram schematically illustrating a stacked structure of a thin film dielectric layer and an internal electrode layer in the ultra thin film capacitor illustrated in FIG. 1A, FIG. 3 is a cross-sectional view schematically illustrating an ultra thin film capacitor according to another exemplary embodiment of the present invention, and FIG. 4A is a cross-sectional view schematically illustrating an ultra thin film capacitor according to an exemplary embodiment of the present invention.

First, referring to FIG. 1A, the ultra thin film capacitor according to the exemplary embodiment of the present invention may be configured to include a substrate 10, a dielectric unit formed of a plurality of thin film dielectric layers 50, an internal electrode unit formed of a plurality of internal electrode layers 30, and via electrodes 70. Further, referring to FIG. 4A, the ultra thin film capacitor according to the exemplary embodiment of the present invention may further include an internal passivation layer 20 and an external passivation layer 80.

In detail, referring to FIG. 1A, the substrate 10 of the ultra thin film capacitor may be made of material, such as silicon, alumina, sapphire, and the like. Further, referring to FIG. 4A, for example, the internal passivation layer 20 may be disposed on the substrate 10. In addition, in another example, an adhesive assist layer 25 may further disposed on the internal passivation layer 20 to improve adhesion with the dielectric unit.

Next, the dielectric unit of the ultra thin film capacitor illustrated in FIG. 1A will be described.

The dielectric unit of the ultra thin film capacitor is formed by stacking the plurality of thin film dielectric layers 50 on the substrate 10. In this case, the thin film dielectric layers 50 are alternately stacked with the plurality of internal electrode layers 30.

Further, in one example, the thin film dielectric layer 50 may be made of BaSrTiO₃ (BST), SrTiO₃, and BaTiO₃, Pb(Zr, Ti)O₃, or bismuth layered compounds, such as SrBi₄Ti₄O₁₅, and the like.

Next, the internal electrode unit of the ultra thin film capacitor illustrated in FIG. 1A will be described.

The internal electrode unit of the ultra thin film capacitor is formed by stacking the plurality of internal electrode layers 30 in the dielectric unit. In this case, the plurality of internal electrode layers 30 are alternately stacked with the plurality of thin film dielectric layers 50 in the dielectric unit on the substrate 10. Further, each internal electrode layer 30 includes first electrode layers 31 and a second electrode layer 33. In this case, each of the first electrode layers 31 of the internal electrode layer 30 has stacked surface contacting adjacent thin film dielectric layer 50 in upper or lower direction. Further, the second electrode layer 33 is formed between the upper and lower first electrode layers 31 and is made of material having a specific resistance lower than that of the first electrode layers 31. FIG. 2A illustrates the internal electrode layer 30 in which the second electrode layer 33 is inserted between the upper and lower first electrode layers 31.

Since each first electrode layer 31 contacting the thin film dielectric layer 50 has a high specific resistance, the second electrode layer 33 having a low specific resistance is attached between the first electrode layers 31 to reduce an internal equivalent series resistance (ESR) of the capacitor.

For example, the first electrode layers 31 may be made of a Pt or Au material.

In one example, the first electrode layers 31 may be made of a Pt material. In this case, the second electrode layer 33 may be made of one metal material of Cu, Ag, Au, Al, Ru, Ir, Ni, Co, Mo, and W.

Meanwhile, when the first electrode layers 31 are made of an Au material, the second electrode layer 33 may be made of one metal material of Cu and Ag.

In this case, one example of the ultra thin film capacitor will be described in more detail with reference to FIG. 3. Referring to FIG. 3, the internal electrode unit of the ultra thin film capacitor may be configured to include a base electrode layer and the plurality of internal electrode layers 30. In this case, the base electrode layer 30a is formed on a bottom portion of the internal electrode unit structure. Further, the plurality of internal electrode layers 30 are alternately stacked with the plurality of thin film dielectric layers 50 over the base electrode layer 30a.

Next, the via electrodes 70 of the ultra thin film capacitor illustrated in FIG. 1A will be described.

The via electrodes 70 of the ultra thin film capacitor are at both sides of the internal electrode unit on the substrate 10. In this case, the via electrodes each are electrically connected alternately with the stacked internal electrode layers 30

For example, referring to FIG. 4A, each via electrode 70 may include an external electrode pad 71 extended and formed on the external passivation layer 80.

Next, other examples of the ultra thin film capacitor according to the first exemplary embodiment of the present invention will be described with reference to FIG. 4A.

Referring to FIG. 4A, in one example, the ultra thin film capacitor may further include the internal passivation layer 20. In this case, the internal passivation layer 20 is formed on the substrate 10 and beneath a coupling structure of the dielectric unit and the internal electrode unit. For example, as the internal passivation layer 20 an inorganic passivation layer of, for example, SiNx, SiOx, TiOx, TaOx, SiON, AlOx, and the like or an organic passivation layer (or organic insulating layer) of, for example, polyimide resin, epoxy resin, and the like, may be used. Further, referring to FIG. 4A, in one example, the adhesive assist layer 25 may be interposed between the internal passivation layer 20 and the coupling structure of the dielectric unit and the internal electrode unit to improve the adhesion therebetween. The adhesive assist layer 25 more strongly adheres the internal passivation layer 20 to the coupling structure of the dielectric unit and the internal electrode unit. Although not illustrated, unlike one illustrated in FIG. 4A, the adhesive assist layer 25 may be further interposed between the substrate 10 and the coupling structure of the dielectric unit and the internal electrode unit even in the structure illustrated in FIG. 1A.

Further, referring to FIG. 4A, in another example, the ultra thin film capacitor may further include the external passivation layer 80. In this case, the external passivation layer 80 encloses the outside of the dielectric unit on the substrate 10. For example, as the external passivation layer 80 the inorganic passivation layer of, for example, SiNx, SiOx, TiOx, TaOx, SiON, AlOx, and the like or the organic passivation layer (or organic insulating layer) of, for example, polyimide resin, epoxy resin, and the like, may be used. Further, referring to FIG. 4A, an insulating layer 60 may be further interposed between the external passivation layer 80 and the dielectric unit. In this case, the insulating layer 60 encloses the outside of the dielectric unit and electrically insulates the dielectric from the outside. For example, the insulating layer 60 may be made of silicon nitride (SiNx) or other insulating material.

Next, an ultra thin film capacitor according to a second exemplary embodiment of the present invention will be described in detail with reference to the accompanying drawings. In this case, the ultra thin film capacitor according to the first exemplary embodiment of the present invention described above and FIG. 3 may be referred, and therefore an overlapping description thereof may be omitted.

FIG. 1B is a cross-sectional view schematically illustrating an ultra thin film capacitor according to another exemplary embodiment of the present invention, FIG. 2B is a diagram schematically illustrating a stacked structure of the thin film dielectric layer 50 and the internal electrode layer 30 in the ultra thin film capacitor illustrated in FIG. 1B, and FIG. 4B is a cross-sectional view schematically illustrating an ultra thin film capacitor according to another exemplary embodiment of the present invention.

Referring to FIG. 1B, the ultra thin film capacitor according to the exemplary embodiment of the present invention may be configured to include the substrate 10, the dielectric unit formed of the plurality of thin film dielectric layers 50, the internal electrode unit formed of the plurality of internal electrode layers 30, and the via electrodes 70. Further, referring to FIG. 4B, the ultra thin film capacitor according to the exemplary embodiment of the present invention may further include the internal passivation layer 20 and the external passivation layer 80. For example, as the internal passivation layer 20 and/or the external passivation layer 80, the inorganic passivation layer of, for example, SiNx, SiOx, TiOx, TaOx, SiON, AlOx, and the like or the organic passivation layer of, for example, polyimide resin, epoxy resin, and the like, may be used.

In this case, the substrate 10 of the ultra thin film capacitor may be made of material, such as silicon, alumina, sapphire, and the like.

The dielectric unit of the ultra thin film capacitor will be described with reference to FIG. 1B. The dielectric unit of the ultra thin film capacitor is formed by stacking the plurality of thin film dielectric layers 50 on the substrate. In this case, the thin film dielectric layers 50 are alternately stacked with the plurality of internal electrode layers 30.

Further, in one example, the thin film dielectric layers 50 may be made of BaSrTiO₃ (BST), SrTiO₃, and BaTiO₃, Pb(Zr, Ti)O₃, or bismuth layered compounds, such as SrBi₄Ti₄O₁₅, and the like.

Next, the internal electrode unit of the ultra thin film capacitor illustrated in FIG. 1B will be described. The internal electrode unit of the ultra thin film capacitor is formed by stacking the plurality of internal electrode layers 30 in the dielectric. The plurality of internal electrode layers 30 are alternately stacked with the plurality of thin film dielectric layers 50 in the dielectric unit on the substrate 10.

In this case, each internal electrode layer 30 includes the first electrode layer 31 and the second electrode layer 33. One surface of the first electrode layer 31 of the internal electrode layer 30 contacts the thin film dielectric layer 50 and the other surface thereof contacts the second electrode layer 33. Referring to FIG. 2B, each of the internal electrode layers 30 is formed so that the first electrode layer 31 and the second electrode layer 33 contact each other and an assembly of the first electrode layer 31 and the second electrode layer 33 is alternately stacked with the thin film dielectric layers 50. The second electrode layer 33 is made of a material having a specific resistance lower than that of the first electrode layer 31. Since the first electrode layer 31 has a high specific resistance, the second electrode layer 33 having a low specific resistance is attached to the first electrode layers 31 to reduce the internal equivalent series resistance (ESR) of the capacitor.

For example, the first electrode layer 31 may be made of a Pt or Au material.

For example, the first electrode layer 31 may be made of a Pt material. In this case, the second electrode layer 33 may be made of one metal material of Cu, Ag, Au, Al, Ru, Ir, Ni, Co, Mo, and W. Meanwhile, when the first electrode layer 31 is made of Au, the second electrode layer 33 may be made of one metal material of Cu and Ag.

Further, referring to a combination of FIGS. 3 and 1B or 4B, in one example, the internal electrode unit of the ultra thin film capacitor may be configured to include the base electrode layer and the plurality of internal electrode layer 30. In this case, the base electrode layer 30a is formed on a bottom portion of the internal electrode unit structure. Further, the plurality of internal electrode layers 30 are alternately stacked with the plurality of thin film dielectric layers 50 over the base electrode layer 30a.

Next, the via electrodes 70 of the ultra thin film capacitor illustrated in FIG. 1B will be described. The via electrodes 70 of the ultra thin film capacitor are at both sides of the internal electrode unit on the substrate 10. In this case, the via electrodes 70 each are electrically connected alternately with the stacked internal electrode layers 30.

For example, referring to FIG. 4B, each via electrode 70 may include the external electrode pad 71 extended and formed on the external passivation layer 80.

Next, other examples of the ultra thin film capacitor according to the second exemplary embodiment of the present invention will be described with reference to FIG. 4B.

Referring to FIG. 4B, in one example, the ultra thin film capacitor may further include the internal passivation layer 20. The internal passivation layer 20 is formed on the substrate 10 and beneath the coupling structure of the dielectric unit and the internal electrode unit. For example, as the internal passivation layer 20 the inorganic passivation layer of, for example, SiNx, SiOx, TiOx, TaOx, SiON, AlOx, and the like or the organic passivation layer of, for example, polyimide resin, epoxy resin, and the like, may be used. Further, referring to FIG. 4B, in one example, the adhesive assist layer 25 may be interposed between the internal passivation layer 20 and the coupling structure of the dielectric unit and the internal electrode unit to improve the adhesion therebetween. Although not illustrated, unlike one illustrated in FIG. 4B, the adhesive assist layer 25 may be further interposed between the substrate 10 and the coupling structure of the dielectric unit and the internal electrode unit even in the structure illustrated in FIG. 1B.

Further, referring to FIG. 4B, in another example, the ultra thin film capacitor may further include the external passivation layer 80. In this case, the external passivation layer 80 encloses the outside of the dielectric unit on the substrate 10. For example, as the external passivation layer 80 the inorganic passivation layer of, for example, SiNx, SiOx, TiOx, TaOx, SiON, AlOx, and the like or the organic passivation layer of, for example, polyimide resin, epoxy resin, and the like, may be used. Further, in one example, the insulating layer 60 may be further interposed between the external passivation layer 80 and the dielectric unit. For example, the insulating layer 60 may be made of silicon nitride (SiNx) or other insulating material.

Next, a manufacturing method of an ultra thin film capacitor according to a third exemplary embodiment of the present invention will be described in detail with reference to the accompanying drawings. In this case, the ultra thin film capacitors according to the first exemplary embodiment of the present invention described above and FIGS. 1A, 2A, 3, and 4A may be referred, and therefore an overlapping description thereof may be omitted.

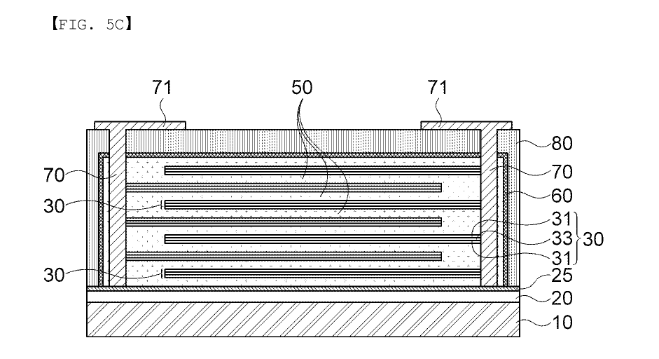

FIGS. 5A to 5C are diagrams schematically illustrating a manufacturing method of an ultra thin film capacitor according to another exemplary embodiment of the present invention. In detail, FIGS. 5A to 5C are diagrams schematically illustrating a manufacturing method of the ultra thin film capacitor illustrated in FIG. 4A. Similarly, the manufacturing method of the ultra thin film capacitor illustrated in FIGS. 1A and 3 may be described with reference to FIGS. 5A to 5C.

Referring to FIGS. 5A to 5C, the manufacturing method of the ultra thin film capacitor according to the exemplary embodiment of the present invention may be configured to include preparing the substrate (See FIG. 5A), forming an internal electrode laminate (See FIG. 5B), and forming via electrodes (See FIG. 5C).

In detail, referring to FIG. 5A, in the preparing of the substrate, the substrate 10 on which the internal electrode laminate is formed is prepared. In this case, the substrate 10 may be made of material, such as silicon, alumina, sapphire, and the like.

Although not illustrated in FIG. 5A, referring to FIG. 5B, in one example, the preparing of the substrate may include forming the internal passivation layer 20 on the substrate. When the internal passivation layer 20 is formed on the substrate in the preparing of the substrate, as illustrated in FIG. 5B, in the forming of the internal electrode laminate, the internal electrode laminate may be formed on the internal passivation layer 20. For example, as the internal passivation layer 20 the inorganic passivation layer of, for example, SiNx, SiOx, TiOx, TaOx, SiON, AlOx, and the like or the organic passivation layer of, for example, polyimide resin, epoxy resin, and the like, may be used.

Further, referring to FIG. 5B, in one example, the preparing of the substrate may further include forming the adhesive assist layer 25 on the internal passivation layer 20. The forming of the adhesive assist layer 25 on the internal passivation layer 20 may be performed in the forming of the internal electrode laminate as illustrated in FIG. 5B, even if not performed in the preparing of the substrate. Referring to FIG. 5B, in the forming of the internal electrode laminate, the internal electrode laminate may be formed on the adhesive assist layer 25.

Next, the forming of the internal electrode laminate will be described with reference to FIG. 5B.

In the forming of the internal electrode laminate, the internal electrode laminate is formed by alternately stacking the plurality of thin film dielectric layers 50 and the plurality of internal electrode layers 30 on the substrate 10. In this case, each internal electrode layer 30 includes the first electrode layers 31 and the second electrode layer 33. Each of the first electrode layers 31 of the internal electrode layer 30 has a stacked surface contacting the thin film dielectric layer 50 in upper or lower direction. Further, the second electrode layer 33 of the internal electrode layer 30 is formed between the upper and lower first electrode layers 31 and is made of material having a specific resistance lower than that of the first electrode layers 31.

In one example, the thin film dielectric layer 50 may be formed by any one of atomic layer deposition (ALD), plasma enhanced atomic layer deposition (PEALD), chemical vapor deposition (CVD), plasma enhanced chemical vapor deposition (PECVD), metalorganic chemical vapor deposition (MOCVD), and physical vapor deposition (PVD) processes.

Further, in one example, the thin film dielectric layer 50 may be made of BaSrTiO₃ (BST).

For example, in the forming of the first electrode layers 31 of each internal electrode layer 30, the first electrode layers 31 may be formed by any one of the ALD, PEALD, CVD, MOCVD, PECVD, and PVD processes.

In addition, in one example, in the forming of the second electrode layer 33 of the internal electrode layer 30, the second electrode layer 33 may be formed by any one of the ALD, PEALD, CVD, MOCVD, PECVD and PVD processes, or a plating process.

For example, the first electrode layers 31 may be made of a Pt or Au material.

In one example, the first electrode layers 31 may be made of a Pt material. In this case, the second electrode layer 33 may be made of one metal material of Cu, Ag, Au, Al, Ru, Ir, Ni, Co, Mo, and W. Meanwhile, when the first electrode layers 31 are made of Au, the second electrode layer 33 may be made of one metal material of Cu and Ag.

To be continued, referring to FIG. 5B, in one example, the forming of the internal electrode laminate may include the forming of the external passivation layer 80. In this case, the external passivation layer 80 encloses the outside of the internal electrode laminate. For example, as the external passivation layer 80 the inorganic passivation layer of, for example, SiNx, SiOx, TiOx, TaOx, SiON, AlOx, and the like or the organic passivation layer of, for example, polyimide resin, epoxy resin, and the like, may be used.

Although not illustrated in FIG. 5B, referring to a combination of FIGS. 5B and 3, in one example, the forming of the internal electrode laminate may include the forming of the base electrode layer and the stacking of the internal electrode layers. In this case, in the forming of the base electrode layer, the base electrode layer 30a is formed as a bottom electrode layer of the internal electrode laminate. Further, in the stacking of the internal electrode layers, the thin film dielectric layers 50 and the internal electrode layers 30 are alternately stacked over the base electrode layer 30a.

Unlike one illustrated in FIG. 3, another example may include only the stacking of the internal electrode layers without the base electrode.

Next, the forming of the via electrodes will be described with reference to FIG. 5C.

In the forming of the via electrodes, via holes are formed at both sides of the internal electrode laminate formed on the substrate 10. A conductive substance is filled in the via holes formed at both sides of the internal electrode laminate to form the via electrode 70. In this case, each of the via electrodes 70 is formed so that the conductive substance filled in the via holes is electrically connected alternately with the stacked internal electrode layers 30.

In one example, referring to FIG. 5C, when the external passivation layer 80 enclosing the outside of the internal electrode laminate is formed in the forming of the internal electrode laminate of FIG. 5B, in the forming of the via electrodes, the via electrodes 70 may be formed by forming the via holes penetrating through the external passivation layer 80 and the internal electrode laminate.

Next, a manufacturing method of an ultra thin film capacitor according to a fourth exemplary embodiment of the present invention will be described in detail with reference to the accompanying drawings. In this case, the ultra thin film capacitors according to the second exemplary embodiment of the present invention described above and FIGS. 1B, 2B, 3, and 4B may be referred, and therefore an overlapping description thereof may be omitted.

Referring to FIGS. 5A to 5C schematically illustrating the manufacturing method of the ultra thin film capacitor illustrated in FIG. 4A, similarly, the manufacturing method of the ultra thin film capacitor illustrated in FIGS. 1B and 4B may be described.

Referring to a combination of FIGS. 1B, 2B, and 4B and 5A to 5C, the manufacturing method of the ultra thin film capacitor according to the exemplary embodiment of the present invention may be configured to include preparing the substrate (see FIG. 5A), forming the internal electrode laminate (see a combination of FIGS. 1B and 2B and 5B), and forming via electrodes (see a combination of FIGS. 1B and 5C).

Referring to FIG. 5A, in the preparing of the substrate, the substrate 10 on which the internal electrode laminate is formed is prepared. In this case, the substrate 10 may be made of material, such as silicon, alumina, sapphire, and the like.

Although not illustrated in FIG. 5A, referring to FIG. 5B, the preparing of the substrate may include forming the internal passivation layer 20 on the substrate. In this case, the internal electrode laminate may be formed on the internal passivation layer 20 later. For example, as the internal passivation layer 20 the inorganic passivation layer of, for example, SiNx, SiOx, TiOx, TaOx, SiON, AlOx, and the like or the organic passivation layer of, for example, polyimide resin, epoxy resin, and the like, may be used.

Further, although not illustrated, referring to FIG. 5B, in one example, the preparing of the substrate may further include forming the adhesive assist layer 25 for improving the adhesion between the internal passivation layer 20 and the internal electrode laminate on the internal passivation layer 20. In this case, the internal electrode laminate may be formed on the adhesive assist layer 25 later.

Next, referring to a combination of FIGS. 1B and 2B and 5B, the forming of the internal electrode laminate will be described. In the forming of the internal electrode, the internal electrode laminate is formed by alternately stacking the plurality of thin film dielectric layers 50 and the plurality of internal electrode layers 30 on the substrate 10. Each of the internal electrode layers 30 includes the first electrode layer 31 and the second electrode layer 33. In this case, one surface of the first electrode layer 31 of the internal electrode layer 30 contacts the thin film dielectric layer 50 and the other surface thereof contacts the second electrode layer 33. The second electrode layer 33 is made of material having a specific resistance lower than that of the first electrode layer 31. Since the first electrode layer 31 has a high specific resistance, the second electrode layer 33 having a low specific resistance is attached to the first electrode layers 31 to reduce the internal equivalent series resistance (ESR) of the capacitor.

In this case, in one example, the thin film dielectric layer 50 may be formed by any one of the ALD, PEALD, CVD, MOCVD, PECVD, and PVD processes.

Further, in one example, the thin film dielectric layer 50 may be made of BaSrTiO₃ (BST).

For example, the forming of the first electrode layer 31 of the internal electrode layer 30 may be formed by any one of the ALD, PEALD, CVD, MOCVD, PECVD, and PVD processes.

Further, in one example, the second electrode layer 33 of the internal electrode layer 30 may be formed by any one of the ALD, PEALD, CVD, MOCVD, PECVD, and PVD processes or the plating process.

For example, the first electrode layer 31 may be made of a Pt or Au material. In one example, the first electrode layer 31 may be made of Pt. In this case, the second electrode layer 33 may be made of one metal material of Cu, Ag, Au, Al, Ru, Ir, Ni, Co, Mo, and W. Meanwhile, when the first electrode layer 31 is made of Au, the second electrode layer 33 may be made of one metal material of Cu and Ag.

To be continued, referring to a combination of FIGS. 1B and 5B, in one example, the forming of the internal electrode laminate may include the forming of the external passivation layer 80. In this case, the external passivation layer 80 encloses the outside of the internal electrode laminate. For example, as the external passivation layer 80 the inorganic passivation layer of, for example, SiNx, SiOx, TiOx, TaOx, SiON, AlOx, and the like or the organic passivation layer of, for example, polyimide resin, epoxy resin, and the like, may be used.

Although not illustrated, referring to a combination of FIGS. 1B, 5B and 3, in one example, the forming of the internal electrode laminate may include the forming of the base electrode layer and the stacking of the internal electrode layers. In this case, in the forming of the base electrode layer, the base electrode layer 30a is formed as a bottom electrode layer of the internal electrode laminate. Further, in the stacking of the internal electrode layers, the thin film dielectric layer 50 and the internal electrode layer 30 are alternately stacked over the base electrode layer. Unlike one illustrated in FIG. 3, another example may include only the stacking of the internal electrode layers without the base electrode.

Next, the forming of the via electrodes will be described with reference to a combination of FIGS. 1B and 5C.

In the forming of the via electrodes, via holes are formed at both sides of the internal electrode laminate formed on the substrate. A conductive substance is filled in the via holes formed at both sides of the internal electrode laminate to form the via electrodes 70. In this case, the via electrodes 70 are formed so that the conductive substance filled in the via holes is electrically connected alternately with the stacked internal electrode layers 30.

In one example, referring to FIGS. 1B and 5C, when the external passivation layer 80 is formed, in the forming of the via electrodes, the via electrodes 70 may be formed by forming the via holes penetrating through the external passivation layer 80 and the internal electrode laminate.

As set forth above, according to the exemplary embodiments of the present invention, it is possible to reduce the internal ESR and the internal ESL by adding the electrode layer having the low specific resistance to the internal electrode layers alternately stacked with the thin film dielectric layers.

According to the exemplary embodiments of the present invention, it is possible to reduce the final chip thickness by using the thin film dielectric, for example, the BaSrTiO₃ (BST) and the thin film electrode, for example, the platinum (Pt) electrode in the semiconductor manufacturing process. Further, according to the exemplary embodiments of the present invention, it is possible to manufacture the capacitor having a thickness thinner than that of the multi-layered ceramic capacitor so as to be able to be implemented in the system in package (SIP) type by being inserted into the embedded substrate 10.

Further, since the total actual length of the electrode is long, the MLCC consisting of tens to hundreds of layers has the high equivalent series inductance (ESL) which is parasitic on the capacitor; however, according to the exemplary embodiments of the present invention, the high-k dielectric can be manufactured in a thin film to have a thin thickness and the electrode can be also manufactured in a thin film to have a thin thickness so as to make the actual length of the electrode short, thereby reducing the ESL. That is, since the MLCC according to the related art has the high ESL value, the higher the frequency, the more the noise is generated to make it difficult to implement matching within the circuit, such that the MLCC has a limitation as the frequency increases; however, in one example of the present invention, since the high-K dielectric is used, the actual area of the electrode can be reduced and the ESL can be reduced accordingly, such that the ultra thin film capacitor can be applied to the high frequency products.

Further, according to the related art, since only the Pt electrode is used as the internal electrode layer 30, the internal electrode resistance may increase and the ESR may increase accordingly; however, according to the exemplary embodiments of the present invention, the conductive layers having the low specific resistance, for example, the metals having the low specific resistance can disposed on and beneath the first electrode layer 31, for example, the electrode layer of Pt, thereby reducing the total resistance of the electrode. In particular, in order to reveal the characteristics of the thin film type dielectric, for example, the BST dielectric, the thin film electrode, for example, the Pt electrode needs to be used. Therefore, according to the exemplary embodiment of the present invention, since the second electrode layer 33 having the low specific resistance is used together with the Pt electrode that is the thin film electrode, the high capacitance can be maintained and the internal resistance can be reduced, thereby manufacturing the capacitor having the low ESR.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

1. An ultra thin film capacitor, comprising:
a substrate;
a dielectric unit formed of thin film dielectric layers alternately stacked with a plurality of internal electrode layers on the substrate;
an internal electrode unit formed of the plurality of internal electrode layers alternately stacked with the thin film dielectric layers in the dielectric unit on the substrate, each internal electrode layer including first electrode layers having stacked surfaces contacting the thin film dielectric layers and a second electrode layer formed between the first electrode layers and made of material having a specific resistance lower than that of the first electrode layer; and
via electrodes formed at both sides of the internal electrode unit on the substrate and each being electrically connected alternately with the stacked internal electrode layers.

2. The ultra thin film capacitor according to claim 1, further comprising:
an internal passivation layer formed on the substrate and beneath a coupling structure of the dielectric unit and the internal electrode unit; and
an external passivation layer enclosing an outside of the dielectric unit on the substrate.

3. The ultra thin film capacitor according to claim 1, wherein the internal electrode unit further includes a base electrode layer formed on a bottom portion thereof and a plurality of internal electrode layers are alternately stacked with the thin film dielectric layers over the base electrode layer.

4. The ultra thin film capacitor according to claim 1, wherein the thin film dielectric layer is made of BaSrTiO₃ (BST), SrTiO₃, BaTiO₃, Pb(Zr,Ti)O₃, or SrBi₄Ti₄O₁₅.

5. The ultra thin film capacitor according to claim 1, wherein the first electrode layer is made of Pt material, and
the second electrode layer is made of one metal material of Cu, Ag, Au, Al, Ru, Ir, Ni, Co, Mo, and W.

6. An ultra thin film capacitor, comprising:
a substrate;
a dielectric unit formed of thin film dielectric layers alternately stacked with a plurality of internal electrode layers on the substrate;
an internal electrode unit formed of a plurality of internal electrode layers alternately stacked with the thin film dielectric layers in the dielectric unit on the substrate, each internal electrode layer being formed by stacking the a first electrode layer and a second electrode layer made of material having a specific resistance lower than that of the first electrode layer; and
via electrodes formed at both sides of the internal electrode unit on the substrate and each being electrically connected alternately with the stacked internal electrode layers.

7. The ultra thin film capacitor according to claim 6, further comprising:
an internal passivation layer formed on the substrate and beneath a coupling structure of the dielectric unit and the internal electrode unit; and
an external passivation layer enclosing an outside of the dielectric unit on the substrate.

8. The ultra thin film capacitor according to claim 6, wherein the thin film dielectric layer is made of BaSrTiO₃ (BST), SrTiO₃, BaTiO₃, Pb(Zr,Ti)O₃, or SrBi₄Ti₄O₁₅.

9. The ultra thin film capacitor according to claim 6, wherein the first electrode layer is made of Pt material, and
the second electrode layer is made of one metal material of Cu, Ag, Au, Al, Ru, Ir, Ni, Co, Mo, and W.

10. A manufacturing method of an ultra thin film capacitor, comprising:
preparing a substrate;
forming an internal electrode laminate by alternately stacking a plurality of thin film dielectric layers and a plurality of internal electrode layers on the substrate, each internal electrode layer including first electrode layers having stacked surfaces contacting the thin film dielectric layers and a second electrode layer formed between the first electrode layers and made of material having a specific resistance lower than that of the first electrode layer; and
forming via electrodes by forming via holes at both sides of the internal electrode laminate formed on the substrate and electrically and alternately connecting conductive substances filled in the via holes to the stacked internal electrode layers.

11. The manufacturing method according to claim 10, wherein the preparing of the substrate includes forming an internal passivation layer on the substrate;
in the forming of the internal electrode laminate, the internal electrode laminate is formed on the internal passivation layer and an external passivation layer enclosing an outside of the internal electrode laminate is formed; and
in the forming of the via electrodes, the via electrodes are formed by forming the via holes penetrating through the external passivation layer and the internal electrode laminate.

12. The manufacturing method according to claim 10, wherein the thin film dielectric layer is formed by any one of ALD, PEALD, CVD, MOCVD, PECVD, and PVD processes.

13. The manufacturing method according to claim 12, wherein the thin film dielectric layer is made of BaSrTiO₃ (BST), SrTiO₃, BaTiO₃, Pb(Zr,Ti)O₃, or SrBi₄Ti₄O₁₅.

14. The manufacturing method according to claim 10, wherein the first electrode layer is formed by any one of the ALD, PEALD, CVD, MOCVD, PECVD, and PVD processes, and
the second electrode layer is formed by any one of the ALD, PEALD, CVD, MOCVD, PECVD and PVD processes, or a plating process.

15. The manufacturing method according to claim 14, wherein the first electrode layer is made of Pt material, and
the second electrode layer is made of one metal material of Cu, Ag, Au, Al, Ru, Ir, Ni, Co, Mo, and W.

16. A manufacturing method of an ultra thin film capacitor, comprising:
preparing a substrate;
forming an internal electrode laminate by alternately stacking a plurality of internal electrode layers and a plurality of thin film dielectric layers on the substrate, each internal electrode layer being formed by stacking a first electrode layer and a second electrode layer made of material having a specific resistance lower than that of the first electrode layer; and
forming via electrodes by forming via holes at both sides of the internal electrode laminate formed on the substrate and electrically and alternately connecting conductive substances filled in the via holes to the stacked internal electrode layers.

17. The manufacturing method according to claim 16, wherein the preparing of the substrate includes forming an internal passivation layer on the substrate;
in the forming of the internal electrode laminate, the internal electrode laminate is formed on the internal passivation layer and an external passivation layer enclosing an outside of the internal electrode laminate is formed; and
in the forming of the via electrodes, the via electrodes are formed by forming the via holes penetrating through the external passivation layer and the internal electrode laminate.

18. The manufacturing method according to claim 16, wherein the thin film dielectric layer is formed by any one of ALD, PEALD, CVD, MOCVD, PECVD, and PVD processes using BaSrTiO₃ (BST).

19. The manufacturing method according to claim 16, wherein the first electrode layer is formed by any one of the ALD, PEALD, CVD, MOCVD, PECVD, and PVD processes, and
the second electrode layer is formed by any one of the ALD, PEALD, CVD, MOCVD, PECVD and PVD processes, or a plating process.

20. The manufacturing method according to claim 19, wherein the first electrode layer is made of Pt material, andthe second electrode layer is made of one metal material of Cu, Ag, Au, Al, Ru, Ir, Ni, Co, Mo, and W.
